(19) United States
(12) Patent Application Publication
(10) Pub. No.: US 2007/0249747 A1
(43) Pub. Date: Oct. 25, 2007

(54) Process for Producing Polymer-Modified Nanoparticle

(75) Inventors: Ryotaro Tsuji, Settsu (JP); Kazuaki Matsumoto, Yao (JP); Yoshiharu Yonemushi, Settsu (JP)

Correspondence Address: BIRCH STEWART KOLASCH & BIRCH, PO BOX 747, FALLS CHURCH, VA, 22040-0747, US

(73) Assignee: Kaneka Corporation, Osaka-shi, Osaka (JP)

(21) Appl. No.: 11/630,574

(22) PCT Filed: Jun. 21, 2005
(86) PCT No.: PCT/JP05/11311

§ 371 Date: Dec. 22, 2006

(30) Foreign Application Priority Data
Jul. 7, 2004 (JP) 2004-200133

(51) Int. Cl. C08J 3/12

(52) U.S. Cl. 522/3; 523/220; 523/300; 523/332; 523/339

(57) ABSTRACT

The present invention provides a process for producing polymer-modified nanoparticles in which all kinds of nanoparticles can be economically and easily isolated and purified, and obtained in the form of nanoparticles strongly bonded to a polymer. Hence, the nanoparticles can be easily formed into a coating or a film. The process includes mixing nanoparticles having a particle diameter of 100 nm or less which are selected from the group consisting of metals, metal oxides, and compound semiconductors, with a vinyl polymer having terminal SH group in a liquid to modify the surfaces of the nanoparticles with the vinyl polymer and then isolating the nanoparticles modified with the vinyl polymer from the solution.

### TECHNICAL FIELD

The present invention relates to a process for producing polymer-modified nanoparticles in which nanoparticles with a particle diameter of 100 nm or less are modified with a vinyl polymer.

### BACKGROUND ART

There has been recently started development of nanoparticles having a particle diameter of 100 nm or less to many applications, such as catalysts, ultraviolet shielding agents, fluorescent materials, luminescent materials, coating materials, and magnetic materials, by utilizing the large surface area and quantum characteristics of nanoparticles. However, it has been difficult to isolate such nanoparticles in a stable disperse state because the nanoparticles have a large surface area and thus easily aggregate. In order to prevent the aggregation of such nanoparticles and stably isolate the nanoparticles, a method of modifying the nanoparticles with a protective agent has been proposed. Examples of such a protective agent include low molecular weight thiols such as dodecanethiol and mercaptoacetic acid, long-chain carboxylic acids such as oleic acid and stearic acid, long-chain amines such as oleylamine and dodecylamine, long-chain phosphine oxides such as trioctylphosphine oxide and tributylphosphine oxide, and coordinating polymers such as polyvinylpyrrolidone and polyvinylpyridine. However, low molecular weight compounds such as dodecanethiol have an insufficient effect of stabilizing nanoparticles and thus have the problem of aggregating nanoparticles when a nanoparticle dispersed liquid is stored for about 1 week at room temperature. In the case of using also a coordinating polymer, it has the problem of long-term stability due to its weak force of adhesion to metal nanoparticles.

As a method for resolving the problems, a method of modifying nanoparticles with a polymer has been proposed. For example, Non-patent Document 1 discloses that gold nanoparticles are modified with polyethylene glycol having an SR group. However, this method includes synthesizing gold nanoparticles in the presence of polyethylene glycol having an SH group, not modifying the nanoparticles separately synthesized. Therefore, usable nanoparticles and solvents are limited. For example, the method cannot be applied to nanoparticles which require a high temperature of 200° C. or more for synthesis, such as iron-containing alloy nanoparticles, copper-containing alloy nanoparticles, and semiconductor nanoparticles. The same method is carried out using SH group-containing polystyrene (Non-patent Document 2). In this case, gold nanoparticles are synthesized in the presence of SH group-containing polystyrene, and there is the same problem as described above. As a method for introducing an SH group into polyethylene glycol or polystyrene, a reaction between a polymer end and a low molecular weight compound having an SH group has been used. However, this reaction is complicated and is unsuitable for industrialization, and thus has the problem of low productivity.

A possible method optimum for synthesizing a polymer having terminal SH group is a reversible addition-fragmentation chain transfer (RAFT) polymerization method. As described in, for example, Patent Document 1 and Non-patent Document 3, RAFT polymerization is radical polymerization using a compound having a dithioester bond as a chain transfer agent. Methods of modifying metal nanoparticles with a polymer obtained by RAFT polymerization are described in Patent Document 2 and Non-patent Documents 4, 5, and 6. However, like in an example using polyethylene glycol or polystyrene, in the methods described in Patent Document 2 and Non-patent Documents 4 and 5, metal nanoparticles are synthesized by reduction in the presence of a polymer, and therefore, usable nanoparticles, solvents, reaction conditions are limited. In Non-patent Document 6, gold nanoparticles are modified with a functional group-containing low molecular weight protective agent, and then a dithioester compound is bonded by utilizing the reactivity of the functional group, followed by RAFT polymerization. This reaction is complicated, not economical because of low yield, and is not suitable for industrialization.

In addition, known applications of the modification with an SH group-containing polymer are only applications to noble metal nanoparticles, and there is no example of applications to transition metal nanoparticles, magnetic nanoparticles, semiconductor nanoparticles, and metal oxide nanoparticles.

Patent Document 1: PCT Japanese Transition Patent Publication No. 2000-515181

Patent Document 2: US2003/0199653 A1

Non-patent Document 1: W. P. Wuelfing et al., J. Am. Chem. Soc., 1998, 120, 12696.

Non-patent Document 2: M. K. Corbierre et al., J. Am. Chem. Soc., 2001, 123, 10411.

Non-patent Document 3: J. Chiefari et al., Macromolecules 1998, 31, 5559.

Non-patent Document 4: A. B. Lowe et al., J. Am. Chem. Soc., 2002, 124, 11562.

Non-patent Document 5: J. Shan et al., Macromolecules 2003, 36, 4526.

Non-patent Document 6: J. Raula et al., Langmuir 2003, 19, 3499.

### DISCLOSURE OF INVENTION

Problem to be Solved by the Invention

The present invention provides a simple process for producing polymer-modified nanoparticles which can be applied to all kinds of nanoparticles and has excellent economy.

Means for Solving the Problem

As a method for solving the above-mentioned problems, the inventors propose the following method.

A process for producing polymer-modified nanoparticles of the present invention includes mixing nanoparticles having a particles diameter of 100 nm or less, which are selected from the group consisting of nanoparticles of metals, metal oxides, and compound semiconductors, and a vinyl polymer having terminal SH group in a liquid to modify the surfaces of the nanoparticles with the vinyl polymer, and then isolating the nanoparticles modified with the vinyl polymer from a solution.

In a preferred embodiment, the nanoparticles and the vinyl polymer having terminal SH group are mixed in a liquid under irradiation of ultrasonic waves.

In a preferred embodiment, the process includes the steps of dispersing or dissolving the nanoparticles and the vinyl polymer having terminal SH group individually in mutually-immiscible solvents, mixing both to migrate the nanoparticles to the polymer solution phase, and separating the polymer solution phase from the other phase.

In a preferred embodiment, the process includes the step of distilling off the solvent from the solution containing the vinyl polymer-modified nanoparticles.

In a preferred embodiment, the process includes the step of mixing the solution of the vinyl polymer-modified nanoparticles with a solvent which does not dissolve the vinyl polymer to isolate the vinyl polymer-modified nanoparticles by precipitation.

In a preferred embodiment, the nanoparticles have a particle diameter of 20 nm or less.

In a preferred embodiment, the nanoparticles have any one of the characteristics such as magnetism, fluorescence, luminescence, and plasmon absorption.

In a preferred embodiment, the nanoparticles are zinc oxide nanoparticles.

In a preferred embodiment, the vinyl polymer having terminal SH group has a plurality of SH terminal groups per molecule.

In a preferred embodiment, the vinyl polymer having terminal SH group has a number-average molecular weight of 2,000 to 100,000.

In a preferred embodiment, the vinyl polymer having terminal SH group has a molecular weight distribution of 1.5 or less which is represented by a ratio of the weight-average molecular weight to the number-average molecular weight.

In a preferred embodiment, the vinyl polymer having terminal SH group is produced by radical polymerization of at least one monomer selected from the group consisting of methacrylic acid, acrylic acid, methacrylates, acrylates, styrene, acrylonitrile, vinyl acetate, vinyl chloride, N-isopropyl acrylamide, N-isopropyl methacrylamide, N,N-dimethyl acrylamide, N,N-dimethyl methacrylamide, N-vinylpyrrolidone, 2-vinylpyridine, 4-vinylpyridine, maleic anhydride, and maleimide.

In a preferred embodiment, the vinyl polymer having terminal SH group is produced by treating, with a treating agent, a polymer synthesized by reversible addition-fragmentation chain transfer polymerization.

In a preferred embodiment, the treating agent is selected from the group consisting of hydrogen-nitrogen bond-containing compounds, bases, and reducing agents.

The present invention also relates to a film formed by casting a solution containing the polymer-modified nanoparticles produced by the above-described process.

In a preferred embodiment, the present invention relates to a film formed by casting in the coexistence of another polymer with the vinyl polymer having terminal SH group.

### ADVANTAGE OF THE INVENTION

The process of the present invention is capable of economically and simply isolating and purifying all kinds of nanoparticles, and the nanoparticles are obtained in a form strongly bonded to the polymer and thus can be easily used for forming a coating or film. Therefore, the process of the present invention permits applications to coating materials, adhesives, tackiness agents, sealing agents conductive paste, electromagnetic shield coatings and films, ultraviolet shield coatings and films, magnetic recording materials, light emitting devices, displays, quantum devices, sensors, DNA chips, and optical memory, which contain various types of nanoparticles.

### BRIEF DESCRIPTION OF THE DRAWINGS

FIG. 1 is a TEM photograph of FePt nanoparticles isolated and purified using SH-terminated PMMA.

FIG. 2 is a drawing showing states of isolated and purified FePt nanoparticles, in which a supernatant after isolation of FePt nanoparticles by the process of the present invention, FePt nanoparticles isolated and purified by the process of the present invention, a liquid phase of a comparative example carried out using a commercial polymer (nanoparticles cannot be isolated), and the separated commercial polymer (not containing nanoparticles) are shown in that order from the left.

FIG. 3 is a TEM photograph of FePt nanoparticles isolated and purified using SH-terminated polystyrene.

FIG. 4 is a TEM photograph of FePt nanoparticles isolated and purified using dodecanethiol.

FIG. 5 is a TEM photograph (the same magnification as in FIG. 6) of CdSe nanoparticles isolated and purified using SH-terminated PMMA.

FIG. 6 is a TEM photograph of CdSe nanoparticles isolated and purified using trioctylphosphine oxide.

FIG. 7 is a TEM photograph of gold nanoparticles isolated and purified using SH-terminated PAS.

FIG. 8 is a TEM photograph of gold nanoparticles isolated and purified using dodecanethiol.

FIG. 9 is a TEM photograph of ZnO nanoparticles isolated and purified using SH-terminated PMMA.

### BEST MODE FOR CARRYING OUT THE INVENTION

Nanoparticles used in the present invention have a particle diameter of 100 nm or less. When the size of nanoparticles exceeds 100 nm, the properties peculiar to nanoparticles are generally vanished to become close to the properties of a bulk. Therefore, even if aggregation occurs, a change in properties due to aggregation is not observed, and stabilization by surface modification becomes meaningless. The composition of the nanoparticles of the present invention is selected from the group consisting of metals, metal oxides, and compound semiconductors.

Examples of a metal as a composition of the nanoparticles of the present invention include, but are not limited to, noble metals such as Au, Ag, Pt, and Pd; transition metals such as Cu, Ni, Co, and Fe; and magnetic metals such as FePt, FeMo, CoPt, FePtAg, FeCoPt, FeCo, FePd, FeAu, FeCu, NiPt, NiPtRu, Ni₂B, and FeCuB. Examples of a metal oxide include, but are not limited to, ZnO, CuO, Cu₂O, TiO₂, SiO₂, SnO, InO, InSnO, Fe₃O₄, γ-Fe₂O₃, CoO, Co₃O₄, NiO, MnO, BaFe₁₂O₁₉, CoFe₂O₃, CoCrFeO₄, MnFe₂O₃, NiFe₂O₃, and ZnFe₂O₃. Examples of a compound semiconductor include, but are not limited to, CdSe, CdS, CdTe, ZnSe, ZnS, ZnTe, GaN, GaAs, iron carbide, PbSe, and InP. Nanoparticles produced by doping the above-described various nanoparticles with other elements may be used. Among these nanoparticles, nanoparticles having any one of properties such as magnetism, fluorescence, luminescence, and plasmon absorption are preferred from the viewpoint of a high industrial value added. For magnetic nanoparticles, FePt, NiPt, CoPt, and FeCo are more preferred from the viewpoint that nanoparticles can be applied to high-density magnetic recording materials. For fluorescent and luminescent nanoparticles, ZnO, ZnSe, ZnS, CdSe, and CdS are more preferred from the viewpoint of high emission intensity and sharp spectra, and ZnO and ZnS are particularly preferred from the viewpoint of low toxicity. For nanoparticles with plasmon absorption, Au and Ag are more preferred from the viewpoint of beautiful coloring.

The nanoparticles used in the present invention preferably have a particle diameter of 50 nm or less and more preferably 20 nm or less because the expressed characteristics become remarkable as the size of the nanoparticles decreases. A process for synthesizing such nanoparticles is not particularly limited. For example, methods described in “Nanoparticles, Building Blocks for Nanotechnology” Edited by Vincent Rotello, Kluwer Academic/Plenum Publishers, New York, 2004 and the documents cited therein can be used.

The process of the present invention includes mixing nanoparticles and an SH group-terminated vinyl polymer in a liquid. In this case, the nanoparticles may be in the form of a solution, a colloidal solution, a suspension, or a dispersion. The SH group-terminated vinyl polymer is preferably in the form of a solution from the viewpoint of high efficiency of reaction with the nanoparticles. In mixing both, a solution containing the nanoparticles and a solution containing the polymer may be separately prepared and then mixed. Alternatively, the nanoparticles may be added directly to a polymer solution, or the polymer may be added to a solution containing the nanoparticles. Since the nanoparticles generally easily aggregate when removed from a liquid, the nanoparticles are preferably used in the form of a colloidal liquid, a suspension, or a dispersion. In addition, the SH group-terminated vinyl polymer is preferably used in the form of a solution containing the polymer, for example, because a reaction solution after solution polymerization can be directly used to permit the omission of a polymer isolation step. Therefore, it is preferred that a solution containing the nanoparticles and a solution containing the polymer are separately prepared and then mixed. In this method, when the solvents of the nanoparticles-containing solution and the polymer-containing solution are immiscible with each other, both phases can be easily separated again after mixing. Therefore, in the step of mixing both, the nanoparticles are bonded to the SH-terminated vinyl polymer to migrate the nanoparticles to the polymer-containing liquid phase from the nanoparticles-containing liquid phase, and then the polymer-containing liquid phase is again separated from the other phase. As a result, impurities contained in the nanoparticles-containing solution can be easily removed. Examples of the impurities include residues derived from the compounds used in synthesis of the nanoparticles, such as salts and ions derived from the reducing agent, salts and ions derived from the nanoparticle precursor, and the protective agent caused to coexist in synthesis of the nanoparticles. Examples of a combination of the immiscible solvents include, but are not limited to, water/toluene, water/chloroform, water/xylene, water/hexane, water/carbon tetrachloride, water/1,2-dichloroethane, methanol/hexane, ethylene glycol/chloroform, ethylene glycol/toluene, propylene glycol/toluene, 1,3-propanediol/toluene, and 1,4-butanediol/toluene.

Examples of a method for mixing the nanoparticles and the SH group-terminated vinyl polymer in a liquid include, but are not particularly limited to, a magnetic or mechanical stirring method, a shaking method, a ultrasonic irradiation method, a spray method, and a method of forming a liquid flow using a liquid feed pump. A plurality of methods may be combined. Among these methods, the magnetic or mechanical stirring method and the ultrasonic irradiation method are preferred in view of a high mixing efficiency, and both methods are more preferably combined. The mixing temperature is not particularly limited, but is preferably in the range of −50° C. to 250° C. and more preferably in the range of 0° C. to 200° C. in view of economics and polymer heat resistance.

Examples of a method for isolating the polymer-modified nanoparticles from the solution include, but are not particularly limited to, (1) a method of distilling off the solvent from the solution, (2) a method of casting the solution to form a film, and (3) a method of mixing the solution with a solvent which does not dissolve the polymer to precipitate the polymer.

The method (1) of distilling off the solvent is not particularly limited, and a rotary evaporator, an evaporator, or an oven may be used, or simple natural drying may be performed. The method (1) may be performed under a reduced pressure or the atmospheric pressure, but a reduced pressure is preferred in view of efficiency. The casting method (2) is not particularly limited, and, for example, any of various coaters such as a bar coater and a spin coater, or a spray may be used, or coating may be performed with a brush. Among these methods, the method using a coater such as a bar coater or a spin coater is preferred from the viewpoint that a uniform film can be obtained within a short time. The method (2) may be performed under a reduced pressure or the atmospheric pressure. In the method (3), a combination of the solvents used is not limited and may be appropriately selected according to the solubility of the polymer used. Examples of good solvents for poly(methyl methacrylate) include xylene, toluene, dichloromethane, chloroform, dioxane, methyl ethyl ketone, ethyl acetate, tetrahydrofuran, dimethylformamide, and acetone. Examples of poor solvents include hexane, cyclohexane, methanol, ethanol, and formamide. In order to sufficiently precipitate the polymer with a combination of such solvents, miscible solvents with each other are preferably used. After the polymer is precipitated, the polymer is isolated by filtration or decantation, and if required, the remaining solvent is removed by drying.

The composition of the SH group-terminated vinyl polymer used in the present invention is not particularly limited. The term “vinyl polymer” means a polymer obtained by polymerization of a radical polymerizable vinyl monomer. Examples of such a radical polymerizable vinyl monomer include, but are not limited to, methacrylates such as methyl methacrylate, ethyl methacrylate, n-butyl methacrylate, tert-butyl methacrylate, 2-ethylhexyl methacrylate, 2-hydroxyethyl methacrylate, and 2-methoxyethyl methacrylate; acrylates such as ethyl acrylate, n-butyl acrylate, and tert-butyl acrylate; methacrylic acid; acrylic acid; methacrylamide; N-isopropyl methacrylamide; N,N-dimethyl methacrylamide; acrylamide; N-isopropyl acrylamide; N,N-dimethyl acrylamide; acrylonitrile; methacrylonitrile; styrene; α-methylstyrene; divinylbenzene; indene; 2-vinylpyridine; 4-vinylpyridine; vinyl chloride; chloroprene; vinylidene chloride; vinyl acetate; N-vinylpyrrolidone; butadiene; isoprene; acrolein; methacrolein; maleic anhydride; maleimide; and maleates. These monomers may be used alone or used in a combination to make a copolymer. Among these monomers, in view of the excellent heat resistance, weather resistance, and solubility in the solvent of the polymer, methacrylates, acrylates, methacrylic acid, acrylic acid, styrene, acrylonitrile, vinyl acetate, vinyl chloride, N-isopropyl acrylamide, N-isopropyl methacrylamide, N,N-dimethyl acrylamide, N,N-dimethyl methacrylamide, N-vinylpyrrolidone, 2-vinylpyridine, 4-vinylpyridine, maleic anhydride, and maleimide are preferred. In view of sufficient reversible addition-fragmentation chain transfer polymerization which will be described below, methacrylates, acrylates, methacrylic acid, acrylic acid, styrene, N-isopropyl acrylamide, N-isopropyl methacrylamide, N,N-dimethyl acrylamide, N,N-dimethyl methacrylamide, and N-vinylpyrrolidone are more preferred.

Although the structure of the SH-terminated vinyl polymer used in the present invention is not particularly limited, the molecular weight distribution represented by the ratio (Mw/Mn) of the weight-average molecular weight (Mw) to the number-average molecular weight (Mn) is more preferably 1.5 or less and most preferably 1.3 or less from the viewpoint that the degree of modification of the nanoparticles is uniform between the nanoparticles and the viewpoint that the distances between the nanoparticles contained in a coating or a film are kept constant. In addition, the number-average molecular weight (Mn) of the polymer is preferably 2,000 to 100,000 and more preferably 3,000 to 50,000. When Mn of the polymer is less than 2000, like in modification with a low molecular weight compound, the stability of nanoparticles is not sufficient and the separation among nanoparticles deteriorates in the stage of isolation and purification. When Mn of the polymer exceeds 100,000, the viscosity of the solution may be increased to cause difficulty in handling, and the relative content of SH groups may be decreased to fail to sufficiently achieve the modification of the nanoparticles.

As the SH-terminated vinyl polymer, a vinyl polymer containing a plurality of terminal SH groups per molecule is preferably used because a strong crosslinked structure including the nanoparticles as crosslinking points can be formed, thereby achieving high durability of a film or a coating. In this case, the vinyl polymer containing a plurality of terminal SH groups per molecule preferably has a molecular weight distribution of 1.5 or less because the distances between the nanoparticles become constant to permit a uniform arrangement of the nanoparticles. The molecular weight distribution is more preferably 1.3 or less.

A method for synthesizing the SH group-terminated vinyl polymer is not particularly limited, but a reversible addition-fragmentation chain transfer (RAFT) polymerization method is preferred from the viewpoint that SH groups can be securely introduced, and the molecular weight and molecular weight distribution can be controlled. As described in Patent Document 1 and Non-patent Document 3, the RAFT polymerization is a method of radical polymerization of a vinyl monomer using as a chain transfer agent a compound having a dithioester structure and is a kind of controlled radical polymerization method. The polymer obtained by this method has a dithioester structure or a trithiocarbonate structure at a molecular end or in the molecular chain. In a preferred embodiment of the present invention, the polymer used is produced by treating a polymer having a dithioester or a trithiocarbonate structure, which is obtained by the RAFT polymerization, with a treating agent to convert the dithioester or the trithiocarbonate structure into an SH group.

The chain transfer agent used in the RAFT polymerization and having the dithioester structure is not particularly limited, and the agent described in Patent Document 1 can be used. However, from the viewpoint of availability and reactivity, the following compounds are preferred: 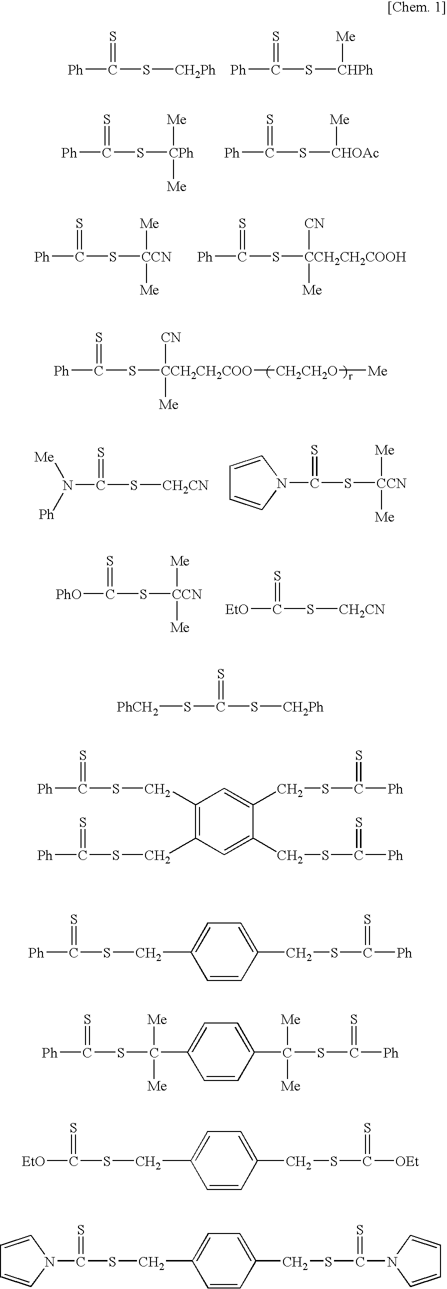
(wherein Me represents a methyl group, Et represents an ethyl group, Ph represents a phenyl group, Ac represents an acetyl group, and r is an integer of 1 or more). Among these compounds, compounds having the trithiocarbonate structure are more preferred from the viewpoint of reactivity. In order to obtain a polymer (multifunctional SH polymer) having a plurality of terminal SH groups per molecule, multifunctional dithioester compounds are more preferred. When the nanoparticles are modified with the multifunctional SH polymer, the polymer takes a crosslinked structure containing the nanoparticles as crosslinking points, therefore a strong coating or film can be formed while maintaining the constant distance between the particles. Since the multifunctional SH polymer in which the molecular weight is controlled to be constant can be easily obtained by the RAFT polymerization, the distances between the nanoparticles can be advantageously controlled.

The reaction conditions of the RAFT polymerization are not particularly limited, and conditions described in Patent Document 1 or publicly known conditions can be used. However, from the viewpoint of reactivity, the reaction temperature is preferably 70° C. or more and more preferably 80° C. or more. Examples of the type of polymerization include, but are not limited to, bulk polymerization, solution polymerization, emulsion polymerization, and suspension polymerization. Among these types, bulk polymerization or solution polymerization is preferred from the viewpoint that after the polymerization, a reaction of conversion to an SH group can be easily achieved.

The treating agent used for converting the polymer obtained by the RAFT polymerization into an SH group-containing polymer is not particularly limited. However, from the viewpoint of high efficiency of conversion to an SH group, a compound selected from the group consisting of hydrogen-nitrogen bond-containing compounds, bases, and reducing agents is preferred.

Examples of hydrogen-nitrogen bond-containing compounds used as the treating agent include, but are not limited to, ammonia, hydrazine, primary amines, secondary amines, amide compounds, amine hydrochlorides, hydrogen-nitrogen bond-containing polymers, and hindered amine light stabilizers (HALS). Examples of the primary amines include methylamine, ethylamine, isopropylamine, n-propylamine, n-butylamine, tert-butylamine, 2-ethylhexylamine, 2-aminoethanol, ethylenediamine, diethylenetriamine, 1,2-diaminopropane, 1,4-diaminobutane, cyclohexylamine, aniline, and phenethylamine. Examples of the secondary amines includes dimethylamine, diethylamine, diisobutylamine, di-2-ethylhexylamine, iminodiacetic acid, bis(hydroxyethyl)amine, di-n-butylamine, di-tert-butylamine, diphenylamine, N-methylaniline, imidazole, and piperidine. Examples of the amide compounds include adipic acid hydrazide, N-isopropyl acrylamide, oleic amide, thioacetamide, formamide, acetanilide, phthalimide, and succinimide. Examples of the amine hydrochlorides include acetamidine hydrochloride, monomethylamine hydrochloride, dimethylamine hydrochloride, monoethylamine hydrochloride, diethylamine hydrochloride, and guanidine hydrochloride. Examples of the hydrogen-nitrogen bond-containing polymers include polyethyleneimine, polyallylamine, and polyvinylamine. Examples of the HALS include Adekastab LA-77 (manufactured by Asahi Denka Kogyo Co., Ltd.), Tinuvin 144 (manufactured by Ciba Specialty Chemicals), and Adekastab LA-67 (manufactured by Asahi Denka Kogyo Co., Ltd.).

Examples of the bases used as the treating agent include, but are not limited to, sodium hydroxide, potassium hydroxide, calcium hydroxide, magnesium hydroxide, aluminum hydroxide, sodium methoxide, sodium ethoxide, magnesium methoxide, sodium carbonate, and potassium carbonate.

Examples of the reducing agents used as the treating agent include, but are not limited to, sodium hydride, lithium hydride, calcium hydride, LiAlH₄, NaBH₄, LiBEt₃H (super hydride), and hydrogen.

These treating agents may be used alone or in combination. From the viewpoint of reactivity, a hydrogen-nitrogen bond-containing compound having a boiling point of 20° C. to 200° C. and a reducing agent are preferred. The amount of the treating agent used is not particularly limited, but is preferably 0.01 to 100 parts by weight and more preferably 0.1 to 50 parts by weight relative to 100 parts by weight of the polymer. The reaction conditions such as the temperature, the presence of the solvent, and mixing conditions are not particularly limited.

The polymer-modified nanoparticles obtained by the process of the present invention can be formed in a film by casting the solution. The casting method is not particularly limited (as described above). The film may not be limited to a self-standing film, including a paint or a coating on a substrate. Since the nanoparticles of the present invention are modified with the polymer, the nanoparticles are excellent in dispersibility in a film and produce substantially no aggregate in the film, as compared with nanoparticles not modified or coated with a low molecular weight compound. Therefore, the characteristics due to the quantum size effect of the nanoparticles, such as fluorescence, luminescence, and plasmon absorption, are significantly accomplished. Furthermore, a transparent film can be obtained because of no aggregation.

In the film formed by the casting method, another polymer may be allowed to coexist with the SH-terminated vinyl polymer. Such a polymer generally functions as a matrix for the nanoparticles modified with the SH-terminated polymer. Examples of the polymer include, but are not limited to, poly(methyl methacrylate), poly(ethyl methacrylate), poly(2-hydroxyethyl methacrylate), poly(2-methoxyethyl methacrylate), poly(n-butyl acrylate), poly(ethyl acrylate), poly(2-hydroxyethyl acrylate), poly(2-methoxyethyl acrylate), poly(methacrylic acid), poly(acrylic acid), polymethacrylamide, polyacrylamide, polystyrene, poly(vinyl chloride), poly(vinylidene chloride), polychloroprene, polyisobutylene, polybutadiene, polyisoprene, polyacrylonitrile, poly(vinyl acetate), polyvinyl alcohol, polyvinylpyrrolidone, polyethylene, polypropylene, poly(ethylene oxide), poly(propylene oxide), poly(ethylene terephthalate), poly(butylene terephthalate), polysiloxane, polyurethane, polyimide, phenol resin, epoxy resin, butyl rubber, natural rubber, poly(ether ether ketone), and polyamide. These polymers may be homopolymers or copolymers each containing two or more monomer components as constituent components of the polymer. The polymers may be used alone or in combination of two or more. In order to uniformly disperse the nanoparticles isolated and purified by the process of the present invention, the polymer is preferably compatible with the SH-terminated vinyl polymer used in the present invention. In order to localize the nanoparticles in a specified portion of a separated phase structure, the polymer phase is preferably separated from the phase of the SH-terminated vinyl polymer. By using the separated phase structure of the polymer, it is possible to form a film or a coating in which the nanoparticles are self-assembled in a specified structure. For example, the nanoparticles can be accumulated in a sea or island portion of a sea-island structure, or the nanoparticles can be localized in a specified portion of a lamella structure, a layered structure, or a co-continuous structure.

Although a typical example of the present invention will be described below, the present invention is not limited to this. A hydrophilic colloidal solution (a) containing nanoparticles having a particle diameter of 30 nm or less and synthesized by a reduction method in a hydrophilic solvent and a hydrophobic solution (b) containing an SH-terminated polymer prepared by RAFT polymerization in a hydrophobic solvent and then modification with an amine or a reducing agent are placed in a vessel and irradiated with ultrasonic waves under mechanical stirring, followed by mixing at a temperature of 100° C. or less. After it is confirmed that the nanoparticles are migrated into the hydrophobic solution (b) phase by still standing, the phase (b) is removed by liquid separation. Although the polymer-modified nanoparticles are dissolved in the phase (b), if required, insoluble substances are removed by centrifugal separation or filtration. Then, the solvent is removed from the resulting solution by spin coater or the like to form a film. When a adhesive film is desired, a polymer having a low glass transition temperature (Tg), such as poly(n-butyl acrylate), is used, while when a hard film is desired, a polymer having high Tg, such as poly(methyl methacrylate) or polystyrene, is used. When a polymer containing a plurality of terminal SH groups per molecule is used, a strongly crosslinked material can be obtained.

### EXAMPLES

Examples of the present invention will be described below, but the present invention is not limited to these examples.

In the present invention, the weight-average molecular weight (Mw) and the number-average molecular weight (Mn) of a polymer were determined by gel permeation chromatographic (GPC) analysis. A hydrophobic polymer was analyzed using a system manufactured by Waters Corporation, Shodex K-806 and K-805 (manufactured by Showa Denko K. K.) columns, chloroform as an eluent, and polystyrene standards. A hydrophilic polymer was analyzed using a Shodex LF-804 (manufactured by Showa Denko K. K.) column, dimethylformamide containing 10 mM of LiBr as an eluent, and poly(ethylene glycol) standards. In polymerization, a conversion of a monomer was determined by gas chromatographic (GC) analysis. GC analysis was performed using a sampled solution which was dissolved in a proper solvent such as ethyl acetate or ethanol, capillary column DB-17 (manufactured by J & W SCIENTIFIC INC.), and gas chromatograph GC-14B (manufactured by Shimadzu Corporation). The particle diameter of nanoparticles was measured with a transmission electron microscope (TEM) JEM-1200EX (manufactured by JEOL, Ltd.) at an acceleration voltage of 80 kV. A nanoparticle dispersed liquid sample was observed by fixing on a mesh to which a collodion membrane was attached. A film sample was observed using an ultrathin slice prepared with an ultramicrotome (Ultracut UCT manufactured by Leica). The independent nanoparticles were counted within a region of 100 μm² or more in a TEM photograph. The number-average particle diameter of the nanoparticles was measured for 100 or more nanoparticles in a TEM photograph using a vernier caliper. As an emission spectrum, a photoluminescence spectrum was measured in the range of 400 to 700 nm using fluorophotometer LS55 (manufactured by Perkin-Elmer Co., Ltd.) and exciting light at 299 nm or in the range of 350 to 700 nm using a spectrofluorometer EP-6500DS (manufactured by JASCO Corporation) and exciting light at 290 to 370 nm. A UV-Vis absorption spectrum was measured using UV visible spectrophotometer UV-3150 (manufactured by Shimadzu Corporation). The haze of a film was measured using a haze meter NDH-300A (manufactured by Nippon Denshoku Industries Co., Ltd.) according to the method described in JIS K7105-1981 6.4.

### Production Example 1

### Production of FePt Nanoparticles

A four-necked flask (200 mL) equipped with a reflux condenser with a nitrogen inlet tube, a mechanical stirrer, and a temperature measuring thermocouple was purged with nitrogen, and 1,2-hexanediol (520 mg), Pt(acac)₂ (197 mg), FeCl₂.4H₂O (139 mg), and diphenyl ether (25 mL) were placed in the flask, followed by heating at 100° C. for 10 minutes under stirring in a nitrogen atmosphere. Then, oleic acid (0.16 mL) and oleylamine (0.17 mL) were added to the mixture, and the resultant mixture was heated at 200° C. for 20 minutes. Next, LiBEt₃H (1M THF solution) (2.5 mL) was added dropwise over 2 minutes. The resulting mixture was further heated at 200° C. for 5 minutes and at 263° C. for 20 minutes under stirring and then allowed to cool.

### Production Example 2

### Production of Poly(Methyl Methacrylate) (PMMA) Having an SH Group at One End

In a four-necked flask (300 mL) equipped with a reflux condenser with a nitrogen inlet tube, a magnetic stirrer, and a temperature measuring thermocouple, 2-(2-phenylpropyl) dithiobenzoate (0.170 g), MMA (50.0 g), toluene (100 g), and 2,2′-azobis(isobutyronitrile) (0.021 g) were placed, followed by nitrogen purge and heating at 90° C. for 2 hours. The consumed monomer was 30%. Then, the reaction mixture was cooled to 70° C., and n-butylamine (0.0935 g) was added to the mixture, followed by stirring at 70° C. for 10 hours. The reaction solution was poured into methanol (400 mL) to obtain PMMA (7.4 g) containing an SH group at one end. As a result of GPC analysis, Mw was 31,600, Mn was 26,200, and Mw/Mn was 1.20.

### Example 1

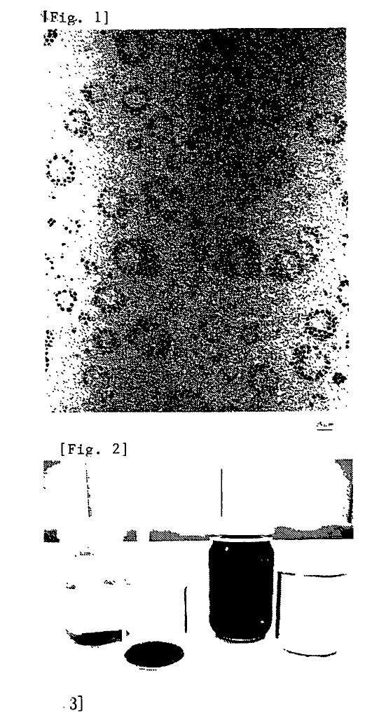

PMMA (0.63 g) obtained in Production Example 2 was placed in a 100 mL eggplant-type flask which was then purged with nitrogen. Then, tetrahydrofuran (THF) (50 mL) was added to the flask to dissolve PMMA with magnetic stirring. Then, the FePt dispersed liquid (4 mL) obtained in Production Example 1 was added to the resultant solution, followed by stirring at room temperature for 1 hour. Then, the reaction solution was poured into n-hexane (100 mL), and the resulting precipitate was recovered by decantation. The dry weight of the precipitate was 0.72 g. FIG. 1 is a TEM photograph of the precipitate. As a result, uniform particles having a number-average particle diameter of 4 nm were obtained without aggregation. Then, toluene (5 mL) was added to the resultant precipitate to dissolve the precipitate, and the solution was allowed to stand at room temperature for 3 months or more. As a result, a precipitate was not observed, and it was confirmed that the particles were stably dissolved.

### Comparative Example 1

The FePt dispersed liquid obtained in Production Example 1 was allowed to stand at room temperature for 1 hour. As a result, a large amount of visually observable precipitate was observed. It was thus confirmed that stability in a solution is inferior to that in Example 1.

### Comparative Example 2

First, ethanol (20 mL) was added to the FePt dispersed liquid (10 mL) obtained in Production Example 1, and the produced precipitate was recovered by centrifugal separation (6000 rpm/10 min). Then, n-hexane (10 mL), oleic acid (0.025 mL), and oleylamine (0.01 mL) were added to the resulting precipitate to dissolve the precipitate. The residual insoluble substances were removed by centrifugal separation (6000 rpm/10 min). Then, ethanol (10 mL) was added to the supernatant, and the produced precipitate was recovered by centrifugal separation (6000 rpm/10 min). Next, n-hexane (10 mL), oleic acid (0.025 mL), and oleylamine (0.01 mL) were added to the precipitate, and the remaining precipitate was removed by centrifugal separation (6000 rpm/10 min). Then, ethanol (10 mL) was added to the supernatant, and the resulting precipitate was recovered by centrifugal separation (6000 rpm/10 min). Furthermore, n-hexane (10 mL), oleic acid (0.025 mL), and oleylamine (0.01 mL) were added to the precipitate to prepare a FePt dispersed liquid.

In comparison with Example 1, troublesome centrifugal separation must be repeated, and oleic acid and oleylamine are required as a stabilizer at each time of separation. Therefore, productivity and economics are inferior. When the resultant FePt dispersion liquid is allowed to stand at room temperature for 1 week, visually observable precipitate is appeared at the bottom of a vessel. Therefore, stability is inferior to that in Example 1.

### Comparative Example 3

The same experiment as in Example 1 was carried out using commercial PMMA Sumipex LG-21 (manufactured by Sumitomo Chemical Co., Ltd.; Mn 44000, Mw/Mn 1.89) (0.63 g) instead of the PMMA used in Example 1. However, the resultant precipitate was composed of only transparent PMMA, and nanoparticles remained dispersed in the solution without being incorporated into the polymer. It was thus confirmed that in the process of the present invention, it is necessary for the polymer to contain an SH group. FIG. 2 shows photographs of the supernatant and precipitate obtained in Example 1, and the supernatant and precipitate obtained in Comparative Example 1 (in that order from the left).

### Production Example 3

### Production of FePt Nanoparticles

In a four-necked flask (300 mL) equipped with a reflux condenser with a nitrogen inlet tube, a mechanical stirrer, and a temperature measuring thermocouple, Fe(acac)₃ (369 mg), a 0.5 N NaOH ethylene glycol solution (33 mL), ethylene glycol (200 mL), and Me₂N(CH₂CH₂O)₃H (1.0 g) were charged, and the flask was purged with nitrogen, followed by heating at 160° C. for 30 minutes under vigorous stirring. In another four-necked flask (200 mL) equipped with a reflux condenser with a nitrogen inlet tube, a mechanical stirrer, and a temperature measuring thermocouple, Pt(acac)₂ (238 mg), a 0.5 N NaOH ethylene glycol solution (17 mL), ethylene glycol (100 mL), and Me₂N(CH₂CH₂O)₃H (0.5 g) were charged, and the flask was purged with nitrogen, followed by heating at 120° C. for 35 minutes under vigorous stirring. A further four-necked flask (500 mL) equipped with a reflux condenser with a nitrogen inlet tube, a mechanical stirrer, and a temperature measuring thermocouple was purged with nitrogen and heated to about 200° C., and the above two solutions were simultaneously charged in the flask using a cannula. The mixed solution was vigorously stirred at 198° C. for 2 hours and then allowed to cool.

### Production Example 4

### Production of Polystyrene Having an SH Group at One End

In a four-necked flask (500 mL) equipped with a reflux condenser with a nitrogen inlet tube, a magnetic stirrer, and a temperature measuring thermocouple, 2-(2-phenylpropyl) dithiobenzoate (3.22 g), styrene (100.3 g), toluene (98.1 g), and 2,2′-azobis(isobutyronitrile) (0.61 g) were placed, followed by nitrogen purge and heating at 70° C. for 14 hours. The conversion of the monomer was 42%. Then, the reaction solution was maintained at 50° C., and diethylamine (25 g) was added to the mixture, followed by stirring for 8 hours. The reaction solution was cooled to room temperature and then poured into methanol (500 mL) to precipitate a polymer. The resultant polystyrene had an Mw of 4,300, and an Mn of 3,700, and an Mw/Mn of 1.16. Also, it was confirmed by ¹H-NMR analysis that one of the ends was converted to an SH group.

### Example 2

An ethylene glycol dispersion liquid (5 mL) of the FePt nanoparticles obtained in Production Example 3 and a solution of polystyrene (100 mg) produced in Production Example 4 in chloroform (10 mL) were mixed, and the resultant mixture was irradiated with ultrasonic waves of 80 W and 38 kHz for 24 hours under stirring in a constant-temperature bath of 20° C. Then, the mixture was allowed to stand to separate into an ethylene glycol layer and a chloroform layer. The chloroform layer washed with pure water (10 mL, three times). The content of the nanoparticles contained in each of the ethylene glycol layer and the chloroform layer was measured by thermogravimetric analysis (TGA). As a result, it was confirmed that 97% of the nanoparticles was migrated to the chloroform layer.

The resulting chloroform solution (2 mL) and a 20% by weight chloroform solution (2 mL) of commercial polystyrene G9305 (manufactured by A & M Styrene Co., Ltd.) (Mw 180,000) were mixed, and the resultant mixture was cast into a vessel with a cap and dried all day at room temperature. The resulting FePt nanoparticle-containing polystyrene film was uniformly transparent and brown and had an average thickness of 60 μm. FIG. 3 shows a TEM photograph of the film. As a result, 90% or more of the nanoparticles were independently dispersed, and aggregated bulk particles were not observed.

### Comparative Example 4

The same experiment as in Example 2 was carried out using dodecanethiol (100 mg) instead of polystyrene (100 mg) produced in Production Example 4 to obtain an ethylene glycol layer and a chloroform layer. As a result of TGA measurement of the ratio of the FePt nanoparticles contained in each of the layers, it was found that only 71% of the nanoparticles were migrated to the chloroform layer. It was thus found that low molecular weight thiol has a low effect on isolation and purification of nanoparticles in spite of the larger molecular number (number of moles) than that of polystyrene in Example 2.

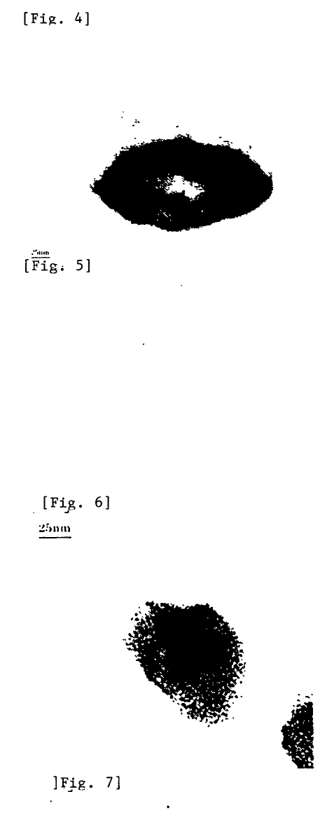

The resultant chloroform solution was cast to form a film (average thickness 60 μm) by the same method as in Example 2. FIG. 4 shows a TEM photograph of the film. As a result, many aggregated bulks of the nanoparticles were present, and only about 12% of the nanoparticles were independently dispersed. By a comparison with Example 2, it was confirmed that the process of the present invention is an optimum isolation and purification process for forming a film containing uniformly dispersed nanoparticles.

### Production Example 5

### Production of CdSe Nanoparticles

In an argon atmosphere in a glove box, selenium powder (0.1 g) and dimethyl cadmium (purity 97%) (0.216 g) were dissolved in tributylphosphine (6.014 g) in a light-shielding glass bottle. In a three-necked flask (30 mL) equipped with a reflux condenser with an argon gas inlet tube, a magnetic stirrer, and a temperature measuring thermocouple, trioctylphosphine oxide (4.0 g) was placed, purged with argon, and then stirred at 360° C. Then, the tributylphosphine solution (2.0 mL) was added to the flask, followed by heating for 20 minutes. After the resultant mixture was cooled to 50° C., purified toluene (2 mL) was added, and anhydrous methanol (10 mL) was further added to the mixture. Insoluble substances were recovered by centrifugal separation (6000 rpm/30 min) and dried at room temperature and reduced pressure all day to obtain powdery CdSe nanoparticles.

### Production Example 6

### Production of PMMA Having an SH Group at One End

In a four-necked flask (200 mL) equipped with a reflux condenser with a nitrogen inlet tube, a magnetic stirrer, and a temperature measuring thermocouple, 2-(2-phenylpropyl) dithiobenzoate (0.272 g), 2,2′-azobis(isobutyronitrile) (0.033 g), MMA (49.9 g), and toluene (50.0 g) were weighed and placed, followed by nitrogen purge. After stirring at 90° C. for 5 hours, the conversion of the monomer was 35%. Then, the reaction solution was cooled to room temperature, and n-butylamine (2.5 g) was added to the mixture, followed by stirring for 5 hours. The reaction solution was poured into methanol (500 mL) to precipitate a polymer. The polymer washed with methanol and then dried to obtain PMMA (12.1 g) having an SH group at one end (Mw 21,600, Mn 18,700, Mw/Mn 1.16). Elemental analysis showed a sulfur content of 0.25% by weight before amine treatment and a sulfur content of 0.14% by weight after the treatment. It was thus confirmed that an end was converted to an SH group.

### Example 3

The CdSe Nanoparticles (2 mg) Produced in Production Example 5, PMMA (500 mg) produced in Production Example 6, and commercial PMMA (manufactured by Sigma-Aldrich Co.) (Mw 120,000) (50 mg) were dissolved in chloroform (9 mL), and the resultant solution was irradiated with ultrasonic waves of 80 W and 38 kHz for 12 hours under stirring in a constant-temperature bath of 23° C. Then, anhydrous methanol (20 mL) was poured into the solution, and insoluble substances were recovered by centrifugal separation (6000 rpm/30 min). The substances were washed with anhydrous methanol, dried at room temperature, and then dissolved in chloroform (5 mL). The solution was cast into a vessel with a cap and dried at room temperature all day. As a result of excitation of the resultant CdSe nanoparticle dispersed film (average thickness 60 μm) with light at a wavelength of 299 nm, the emission peak wavelength was 515 nm, and the half-width was 55 nm. FIG. 5 shows a TEM photograph of the film. The CdSe nanoparticles were stably isolated and purified without aggregation.

### Comparative Example 5)

The CdSe nanoparticles (2 mg) produced in Production Example 5, trioctylphosphine oxide (8 mg), and commercial PMMA (manufactured by Sigma-Aldrich Co.) (Mw 120,000) (92 mg) were dissolved in chloroform (9 mL), and a cast film (average thickness 60 μm) was obtained by the same method as in Example 3. As a result of excitation at a wavelength of 299 nm, the emission peak wavelength was 532 nm, and the half-width was 70 nm. The emission peak wavelength varies according to the particle diameter of the CdSe nanoparticles, and the emission wavelength shifts to the long wavelength side as the particles diameter increases. Also, the half-width of the emission spectrum increases as the particle diameter distribution widens. Therefore, it was confirmed by comparison between Example 3 and Comparative Example 5 that the process of the present invention is capable of stably isolating and purifying CdSe nanoparticles having a small particle diameter. In a TEM photograph of FIG. 6, in Comparative Example 5, bulk particles due to aggregation were observed. Therefore, the above-described fact was supported.

### Production Example 7)

### Production of Poly(Acrylonitrile/Styrene) (PAS) Having an SH Group at One End

In a four-necked flask (1 L) equipped with a reflux condenser with a nitrogen inlet tube, a magnetic stirrer, and a temperature measuring thermocouple, 2-(2-phenylpropyl) dithiobenzoate (1.35 g), acrylonitrile (100.3 g), styrene (100.4 g), toluene (200.1 g), and 2,2′-azobis(isobutyronitrile) (0.30 g) were placed, followed by nitrogen purge. After stirring at 70° C. for 10 hours, the reaction solution was cooled to room temperature and then poured into methanol (2.5 L) to precipitate a polymer. The polymer washed with methanol and dried to obtain PAS (91.6 g) having a thiocarbonylthio group at one end (Mw 31,300, Mn 25,800, Mw/Mn 1.21; acrylonitrile/styrene molar ratio=50/50).

The resultant polymer was dissolved in acetone (220 mL), and diethylamine (45.1 g) was added to the solution, followed by stirring at room temperature for 30 hours. The mixture was poured into methanol (2.5 L) to precipitate a polymer. The polymer washed with methanol and dried to obtain PAS (88.3 g) having an SH group at one end. As a result of elemental analysis, the sulfur content was 0.28% by weight before amine treatment and 0.14% by weight after the treatment. It was thus confirmed that a thiocarbonylthio group was converted to an SH group.

### Example 4

An aqueous colloidal solution (3 mmol/L) (5 mL) (produced by Nanolab Co., Ltd.) of gold nanoparticles synthesized by reduction of chloauric acid with tannic acid and a solution of PAS (40 mg) produced in Production Example 7 in chloroform (10 mL) were mixed. The resultant mixture was irradiated with ultrasonic waves of 80 W and 38 kHz for 24 hours under stirring in a constant-temperature bath of 20° C. to migrate the gold nanoparticles from an aqueous layer to a chloroform layer. Then, the mixture was allowed to stand to separate into the aqueous layer and the chloroform layer to obtain a chloroform solution of the gold nanoparticles. The solution was stable without precipitation even when allowed to stand at room temperature for half a year or more. A 20% by weight chloroform solution of acrylonitrile/styrene copolymer resin (manufactured by Polyscience Inc.; acrylonitrile/styrene molar ratio=25:75), which was separately prepared, was mixed with the gold nanoparticle chloroform solution at 1:1 to prepare a uniform solution. The resultant solution was cast into a vessel with a cap and dried at room temperature all day. The resulting film was uniformly transparent and purplish and had an average thickness of 60 μm. FIG. 7 shows a TEM photograph of the film. The number-average particle diameter was 3 nm, and the ratio of independently dispersed particles was 99%. Also, the UV-Vis absorption peak wavelength of the film was 541 nm.

### Comparative Example 6

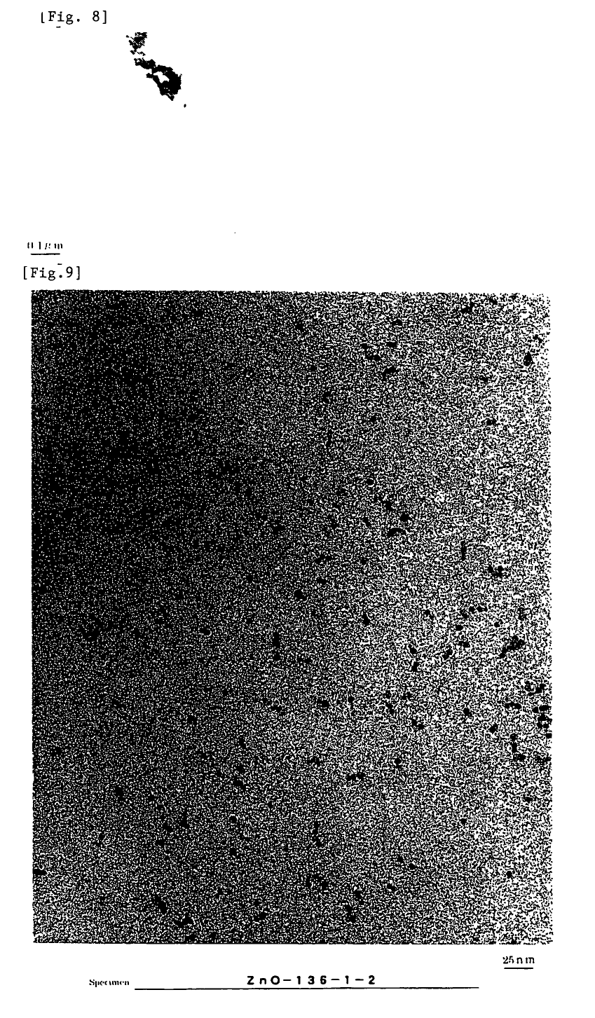

A cast film (average thickness 60 μm) was formed by the same method as in Example 4 except that dodecanethiol (40 mg) was used instead of PAS. As a result, aggregated particles were observed in the film with naked eyes, and the film assumed uneven blue. FIG. 8 shows a TEM photograph of the film. The ratio of independently dispersed particles was 5%, and the UV-Vis absorption peak wavelength of the film was 571 nm. It was confirmed by comparison between Example 4 and Comparative Example 6 that the process of the present invention is capable of dispersing and stably isolating and purifying gold nanoparticles.

### Comparative Example 7

An aqueous colloidal solution (3 mmol/L) (5 mL) (produced by Nanolab Co., Ltd.) of gold nanoparticles synthesized by reduction of chloauric acid with tannic acid was allowed to stand at room temperature. As a result, a precipitate was produced after 1 week. It was confirmed by comparison with Example 4 that the purification process of the present invention is effective in stabilizing nanoparticles.

### Production Example 8

### Production of ZnO Nanoparticles

In a four-necked flask (3 L) equipped with a reflux condenser with a nitrogen inlet tube, a magnetic stirrer, and a temperature measuring thermocouple, isopropanol (1.8 L), zinc acetate dihydrate (20 g), and potassium hydroxide (10.2 g) were placed, and the mixture was heated to 50° C. and stirred for 3 hours. After the mixture was cooled to room temperature, a UV-Vis absorption spectrum and an emission spectrum (314 nm excitation) were measured. As a result, an absorption spectrum peak was shown at 320 nm, and an emission spectrum was shown at 510 nm.

### Production Example 9

### Production of PMMA Having an SH Group at One End

PMMA having an SH group at one end was produced by the same method as in Production Example 6. However, an 1 L flask was used, and 2-(2-phenylpropyl) dithiobenzoate (8.01 g), 2,2′-azobis(isobutyronitrile) (1.11 g), MMA (500.8 g), and toluene (260.1 g) were used. The monomer conversion was 44%. One of the ends was converted to an SH group with n-butylamine (30 g). As a result of GPC analysis, Mw was 16,100, Mn was 13,100, and Mw/Mn was 1.23.

### Example 5

PMMA (0.9 g) having an SH group at one end produced in Production Example 9 was dissolved in dimethylformamide (18 mL), and the resultant solution was mixed with the ZnO/isopropanol solution (18 mL) produced in Production Example 8. After stirring for 1 hour, the mixture was poured into methanol (600 mL) to precipitate PMMA. The PMMA was dissolved in dichloromethane (12 g) together with commercial PMMA (Sumipex MH; manufactured by Sumitomo Chemical Co., Ltd.) (2.1 g), and the resultant solution was cast to form a film. The resulting film had a thickness of 78 μm, and a haze of 0.15% and thus had high transparency. It was confirmed that the film contained ZnO with an ash content of 1.01% equal to a calculated value (1%). The film (10 mg) was dissolved in chloroform (3.5 mL), and an emission spectrum was measured with exciting light at 314 nm. As a result, a spectrum with an intensity peak of 395 was shown at 541 nm. The results are shown in Table 1. FIG. 9 shows a TEM photograph of the film. It was found that ZnO nanoparticles having a number-average particle diameter of 4 nm are dispersed without aggregation.

### Example 6

A film was formed by the same method as in Example 5 except that 1.5 g of the PMMA having an SH group at one end was used, and 1.5 g of commercial PMMA was used.

### Comparative Example 8

A film was formed by the same method as in Example 6 except that commercial PMMA (Sumipex MH; manufactured by Sumitomo Chemical Co., Ltd.) was used instead of the PMMA having an SH group at one end. The results are shown in Table 1.

Table 1 indicates that the polymer-modified nanoparticles produced by the process of the present invention can be dispersed in a resin without aggregation, and exhibits high transparency and high emission intensity.

TABLE 1

| | Ash | | Film | |
|---|---|---|---|---|
| | content | Haze | thickness | Emission |
| | (%) | (%) | (μm) | intensity |
| Example 5 | 1.01 | 0.15 | 78 | 395 |
| Example 6 | 0.98 | 0.16 | 79 | 437 |
| Comparative | 0.60 | 5.50 | 80 | 75 |
| Example 8 | | | | |

1. A process for producing polymer-modified nanoparticles comprising mixing nanoparticles having a particles diameter of 100 nm or less, which are selected from the group consisting of nanoparticles of metals, metal oxides, and compound semiconductors, and a vinyl polymer having a terminal SH group in a liquid to modify the surfaces of the nanoparticles with the vinyl polymer, and then isolating the nanoparticles modified with the vinyl polymer from the solution.

2. The process according to claim 1, wherein the nanoparticles and the vinyl polymer having terminal SH group are mixed in a liquid under irradiation of ultrasonic waves.

3. The process according to claim 1 or 2, comprising the steps of dispersing or dissolving the nanoparticles and the vinyl polymer having terminal SH group individually in mutually-immiscible solvents, mixing both to migrate the nanoparticles to a polymer solution phase, and separating the polymer solution phase from the other phase.

4. The process according to claim 1, comprising the step of distilling off a solvent from the solution containing the vinyl polymer-modified nanoparticles.

5. The process according to claim 1, comprising the step of mixing the solution of the vinyl polymer-modified nanoparticles with a solvent which does not dissolve the vinyl polymer to isolate the vinyl polymer-modified nanoparticles by precipitation.

6. The process according to claim 1, wherein the nanoparticles have a particle diameter of 20 nm or less.

7. The process according to claim 1, wherein the nanoparticles have any one of the characteristics which includes magnetism, fluorescence, luminescence, and plasmon absorption.

8. The process according to claim 1, wherein the nanoparticles are zinc oxide nanoparticles.

9. The process according to claim 1, wherein the vinyl polymer having terminal SH group has a plurality of terminal SH groups per molecule.

10. The process according to claim 1, wherein the vinyl polymer having terminal SH group has a number-average molecular weight of 2,000 to 100,000.

11. The process according to claim 1, wherein the vinyl polymer having terminal SH group has a molecular weight distribution of 1.5 or less which is represented by a ratio of the weight-average molecular weight to the number-average molecular weight.

12. The process according to claim 1, wherein the vinyl polymer having terminal SH group is produced by radical polymerization of at least one monomer selected from the group consisting of methacrylic acid, acrylic acid, methacrylates, acrylates, styrene, acrylonitrile, vinyl acetate, vinyl chloride, N-isopropyl acrylamide, N-isopropyl methacrylamide, N,N-dimethyl acrylamide, N,N-dimethyl methacrylamide, N-vinylpyrrolidone, 2-vinylpyridine, 4-vinylpyridine, maleic anhydride, and maleimide.

13. The process according to claim 1, wherein the vinyl polymer having terminal SH group is produced by treating a polymer synthesized by reversible addition-fragmentation chain transfer polymerization with a treating agent.

14. The process according to claim 13, wherein the treating agent is selected from the group consisting of hydrogen-nitrogen bond-containing compounds, bases, and reducing agents.

15. A film formed by casting a solution containing the polymer-modified nanoparticles produced by the process according to claim 1.

16. The film according to claim 15, wherein in forming the film by casting, another polymer coexists with the vinyl polymer having terminal SH group.
